(19) United States
(12) Patent Application Publication
(10) Pub. No.: US 2019/0155755 A1
(43) Pub. Date: May 23, 2019

(54) A METHOD OF DATA DECRYPTION FOR THE PHYSICAL IMAGE OF A FLASH MEMORY CHIP

(71) Applicant: XLY SALVATIONDATA TECHNOLOGY INC., NeiJiang, Sichuan (CN)

(72) Inventors: Xiaoning LIANG, NeiJiang (CN); Jiaqiang ZHANG, NeiJiang (CN)

(73) Assignee: XLY SALVATIONDATA TECHNOLOGY INC., NeiJiang, Sichuan (CN)

(21) Appl. No.: 15/759,569

(22) PCT Filed: Dec. 5, 2016
(86) PCT No.: PCT/CN2016/108501

§ 371 Date: Mar. 13, 2018

(30) Foreign Application Priority Data
Dec. 7, 2015 (CN) 201510894347.X

(51) Int. Cl. G06F 12/14; G06F 12/02; G06F 9/30; H04L 9/06; H04L 9/08

(52) U.S. Cl. CPC G06F 12/1425; G06F 12/1408; H04L 9/0819; G06F 9/30029; H04L 9/06; G06F 12/0246

(57) ABSTRACT

A method of data decryption for the physical image of a flash memory chip includes the following steps: 001—Zero-filling the logical data of a USB flash drive to obtain the physical data, removing the management bytes in the physical data to obtain a key; 002—Dividing area for the key according to the structure of the flash memory chip to obtain the algorithm of the main control key. The way of data storage is discovered through multiple experiments: The data stored on the chip is the data generated from the XOR operation on the logical data with the key from encryption algorithm. All the keys generated by the main control are obtained through zero-filling of the logical data, and their encryption method can be obtained through simple analysis on all the keys. The data extracted from the flash memory chip when the USB flash drive is damaged will be readable.

### FIELD OF THE INVENTION

The present invention belongs to the technical field of data recovery, and in particular relates to a method of data decryption for the physical image of a flash memory chip.

### BACKGROUND OF THE INVENTION

In today's information era, the importance of data has been increasingly embodied in people's lives. Data security has become a realistic issue that people have to confront in daily life and work. With the rapid development of science and technology, storage media have also developed from the hard-disk magnetic media storage to diversified storage. Flash memory chip is one of the most widely used types of nascent storage carriers. However, owing to the distinctiveness of storage principle and restriction of its life cycle, the probability of a flash memory failure is multiplied as compared with that of a hard disk drive. In case of failure, the data saved in the flash memory will be unreadable.

The reasons that the user data is unreadable fall into two types: One is that the flash memory device is logically damaged. Generally, the flash memory device can be recognized by the operating system when it is connected to the computer, but user data cannot be accessed via standard mode of the operating system. In this case, we can use some simple data recovery tools for logic-layer to recover the data. The other is that the flash memory device is physically damaged. This may be due to the damage of the main controller, crystal oscillator, interface, PCB board and other components, which makes the data in the chip unreadable. This kind of damage can be resolved by replacing with the same components. There is another serious fault, namely, the loss of the firmware of the main control chip or flash memory chip, leading to the failure of reading the data in the flash memory chip. This kind of damage is more common than logical damage. In order to recover the unreadable data resulted from such faults, the flash chip needs to be removed from the PCB board for data reading and recovery.

The data in a USB flash drive is mapped by the main control algorithm (logical data), but the data (physical data) on the chip is encrypted and unordered. Therefore, the data extracted after physical imaging cannot be read directly, and the algorithm should be decrypted in the first place. However, with the development of the times, the USB flash drive capacity has been increasing and the encryption method is getting more and more complicated. The common encryption method (reversal bit, exchange, etc.) have rarely been used, which brings many inconveniences to data recovery and forensic work by public security organs.

### SUMMARY OF THE INVENTION

The present invention provides a method of data decryption for the physical image of a flash memory chip, which can effectively solve the problem that the data extracted from a flash memory chip cannot be directly read when a USB flash drive is damaged.

To solve the above problems, the present invention adopts the following technical solution: A method of data decryption for the physical image of a flash memory chip, comprising the following steps:

001—Zero-filling the logical data of a USB flash drive to obtain the physical data, removing the management bytes in the physical data to obtain a key;

002—Dividing area for said key according to the structure of the flash memory chip to obtain the algorithm of the main control key.

Preferably, 001 comprises the following steps :

101—Zero-filling said logical data in a USB flash drive;

102—Separating said flash memory chip from the circuit board to read the physical data in said flash memory chip;

103—Removing the management bytes in said physical data to obtain said key.

Preferably, 103 comprising the steps of:

1031—Searching said flash memory chip's datasheet and analyze said flash memory chip's page structure;

1032—According to page structure, deleting intra-page management bytes using winhex script.

Preferably, 002 comprising the following steps:

201—Determining an intra-page encryption method;

202—Determining an intra-block encryption method;

203—Determine an inter-block encryption method.

Preferably, the main control model of said USB flash drive is SSS6691, said flash memory model is TC58NVG5D2FTAIO, and said page size is 8832 bytes, with a 4G chip comprising 256 blocks.

Preferably, said page structure of the chip is (1024+46)*8+272, indicating that there are 46 bytes for management bytes following each 1024 bytes of user data in one said page and there are 272 bytes for management bytes at the end of said page.

Preferably, said algorithm of the main control key is as below:

201—Determining the relation between the key of each section in said page: Taking the key of the first section as a basic key, the key of section n will be a result acquired by that each byte of said basic key circular shift left by n−1 bits, wherein, 0<n<=8 ,n is an integer;

202—Determining a relation between the basic key of each page, namely, an intra-block encryption method; said basic key of each said page is the result acquired by that said basic key of said previous page circular shift left by 1 byte, with another one byte filled for the rightmost byte;

203—the inter-block encryption method is the same, that is, the key in each block is the same.

The advantageous effects of the present invention are as follows: The present invention discovers the way of data storage through multiple experiments: The data stored on the chip is the data generated from the XOR operation on the logical data with the key from encryption algorithm. All the keys generated by the main control are obtained through zero-filling the logical data, and their encryption method can be obtained through simple analysis on all the keys. Furthermore, the data extracted from the flash memory chip when the USB flash drive is damaged will be readable, which is convenient for data recovery and forensic work by public security organs.

### BRIEF DESCRIPTION OF THE DRAWINGS

FIG. 1 is the schematic diagram of the main flow chart;

FIG. 2 is the detailed flow chart of obtaining the chip data;

FIG. 3 is the detailed flow chart of reading the physical data;

FIG. 4 is the detailed flow chart of obtaining the key;

FIG. 5 is the flow chart of the algorithm analysis.

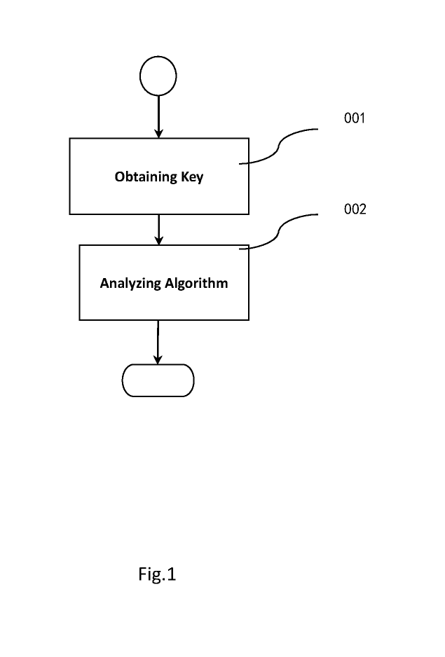

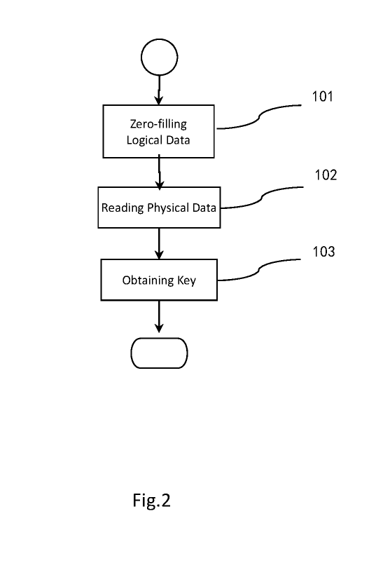

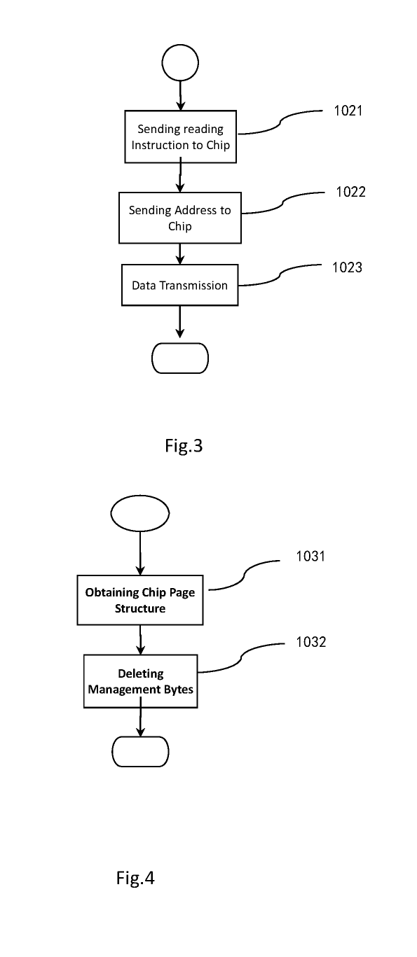

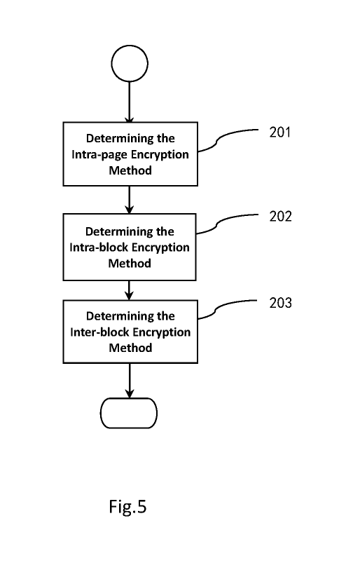

### DETAILED DESCRIPTION OF THE PREFERRED EMBODIMENTS

In order to make the objectives, technical solutions and advantages of the present invention clearer, the present invention will be further described by using the accompanying drawings and the embodiments.

Principle description: data is read with a page and erased with a block (a block comprises multiple pages), and writing falls into new writing and rewriting. New writing can be easily conducted by allocating a free block. However, rewriting follows erasing which requires the following steps: (1) labeling the old data block as an invalid block; (2) allocating the spare blocks to write new data and remapping addresses; (3) erasing data if the number of the spare blocks is less than a certain threshold; (4) merging the valid data in the erasing algorithm, releasing the spare blocks, erasing with banlance management for writing. Since the times of rewriting each block in the flash memory device are limited, in order to prolong its life cycle, the flash memory device adopts technology of banlance management for writing (also known as technology of average writing) to manage the rewriting times of the blocks, that is, keep the write times of each block consistent so that the block's life cycle reaches its extreme limit. Therefore, random writing will appear. Appropriate management bytes will be written accordingly during the course of data (page) writing, including the ID and ECC check code of the current data as well as the flags for distinguishing the management area and the data area.

Embodiment: A method of data decryption for the physical image of a flash memory chip. The main control model of the USB flash drive used in this embodiment is SSS6691, the flash memory model is TC58NVG5D2FTAIO, and the page size is 8832 bytes, with a 4G Toshiba chip comprising 256 blocks.

001—Zero-filling the logical data in the USB flash drive. Since the physical data is generated from encryption and the result from the XOR operation on the logical data with the key from encryption algorithm. Zero-filling the logical data to obtain the physical data, removing the management bytes in the physical data to obtain a key;

002—Dividing area for the key according to the structure of the flash memory chip to obtain the algorithm of the main control key.

101—Zero-filling the logical data in the USB flash drive;

102—Separating the flash memory chip from the circuit board to read the physical data in the flash memory chip;

103—Removing the management bytes in the physical data to obtain a key.

1021—In the case that the chip enable signal CE is valid, firstly, Enable Instruction latch signal CLE. At this point, writing enable signal WE is valid, and the chip is in the ready state. The R/B signal is set at high level to indicate the readiness. At the same time, send reading instruction (0x00 or 0x01) to I/O port to instruct the chip to read now;

1022—In this case, the chip enable signal CE, the address enable signal ALE and writing enable signal WE are all valid. Address data of four consecutive clock cycles are sent. After the address register receives the address value, the R/B signal will remain “busy” for a period of time, then R/B is ready state;

1023—Each time the reading enable signal RE is valid when set at low level, a set of data will be output, which will be repeated until all the data is output.

1031—Searching the flash memory chip's datasheet and analyzing the flash memory chip's page structure; the page structure of the chip is (1024+46)*8+272, indicating that there are 46 bytes for management bytes following each 1024 bytes of user data in one page and there are 272 bytes for management bytes at the end of the page.

1032—According to page structure, deleting intra-page management bytes using below winhex script:

goto 0
{
move 1024
assign SABegin currentpos
move (46-1)
assign SAEnd currentpos
block SABegin SAEnd 6
remove
move −45
} [8]
assign SABegin currentpos
move (272-1)
assign SAEnd currentpos
block SABegin SAEnd
remove
move −271

201—Determining the relation between each section key in the page: the key of the first section of the first page is 0x80, 0x9e, 0x9c, 0x3c (taking the first 4 bytes as example); the key of the second section is 0x01, 0x3d, 0x39, 0x78 and the key of the third section is 0x02, 0x7a, 0x72, 0xf0. It is found that the key of each section is a result acquired by that each byte of the key of the previous page circular shift left by 1 bit, and so it is for the following pages; Taking the key of the first section of a page as a basic key, the key of section n will be a result acquired by that each byte of the basic key circular shift left by n−1 bits, wherein, 0<n<=8 ,n is an integer;

202—Determining the relation between the basic key of each page, namely, the intra-block encryption method; the basic key of the first page is 0x80, 0x9e, 0x9c, 0x3c; the basic key of the second page is 0x9e, 0x9c, 0x3c, 0x25, and henceforth the basic key of each page is a result acquired by that the basic key of the previous page circular shift left by 1 byte, with another one byte filled for the rightmost byte;

203—the inter-block encryption method is the same, that is, the key in each block is the same. The key consists of a main key of 1024 bytes and a supplementary key of 255 bytes. Encryption method: the basic key of page n will be a result acquired by that the main key circular shift left by (n−1) bits, and the key of section n of the page will be a result acquired by that the basic key of the current page circular shift left by (n−1) bits.

It will be evident to those skilled in the art that the forgoing embodiment is considered to be illustrative in details to help fully understand the present invention and not restrictive. The present invention is protected in a way not limited to the details of the foregoing illustrated descriptions and embodiments. Those skilled in the art may come up with other specific variations and combinations under the enlightenment of the technologies as disclosed by the present invention without departing from the spirit or essential attributes thereof. Such variations and combinations still fall within the protection scope of the present invention.

1. A method of data decryption for the physical image of a flash memory chip, wherein said method comprises the following steps:
001—Zero-filling the logical data of a USB flash drive to obtain the physical data, removing the management bytes in said physical data to obtain a key;
002—Dividing area for said key according to the structure of a flash memory chip to obtain the algorithm of a main control key.

2. A method of data decryption for the physical image of a flash memory chip according to claim 1, wherein 001 comprises the following steps:
101—Zero-filling said logical data in said USB flash drive ;
102—Separating said flash memory chip from a circuit board to read said physical data in said flash memory chip;
103—Removing said management bytes in said physical data to obtain said key.

3. A method of data decryption for the physical image of a flash memory chip according to claim 2, wherein 103 comprises the following steps:
1031—Searching said flash memory chip's datasheet and analyzing said flash memory chip's page structure;
1032—Deleting the winhex script for intra-page management bytes according to said page structure.

4. A method of data decryption for the physical image of a flash memory chip according to claim 2, wherein 002 comprises the following steps:
201—Determining an intra-page encryption method;
202—Determining an intra-block encryption method;
203—Determining an inter-block encryption method.

5. A method of data decryption for the physical image of a flash memory chip according to claim 1, wherein the main control model of said USB flash drive is SSS6691, said flash memory model is TC58NVG5D2FTAIO, and said page size is 8832 bytes, with a 4G flash memory chip comprising 256 blocks.

6. A method of data decryption for the physical image of a flash memory chip according to claim 5, wherein said page structure of said flash memory chip is (1024+46)*8+272, indicating that there are 46 bytes for management bytes following each 1024 bytes of user data in one said page and there are 272 bytes for management bytes at the end of said page.

7. A method of data decryption for the physical image of a flash memory chip according to claim 6, wherein said algorithm to obtain said main control key is as follows:
201—Determining a relation between the key of each section in said page: Taking the key of the first section of a page as a basic key, the key of section n will be a result acquired by that each byte of said basic key circular shift left by n−1 bits, wherein, 0<n<=8 ,n is an integer;
202—Determining a relation between the basic key of each page, namely, an intra-block encryption method; said basic key of each said page is the result acquired by that said basic key of said previous page circular shift left by 1 byte, with another one byte filled for the rightmost byte;
203—An inter-block encryption method is the same, that is, the key in each block is the same.

8. A method of data decryption for the physical image of a flash memory chip according to claim 3, wherein 002 comprises the following steps:
201—Determining an intra-page encryption method;
202—Determining an intra-block encryption method;
203—Determining an inter-block encryption method.
